(19) United States
(12) Patent Application Publication
(10) Pub. No.: US 2025/0125422 A1
(43) Pub. Date: Apr. 17, 2025

(54) HYBRID ELECTROLYTE

(71) Applicant: Rivian IP Holdings, LLC, Irvine, CA (US)

(72) Inventors: Judith Alvarado KIM, San Leandro, CA (US); Woochul SHIN, Fremont, CA (US); Byoungchul YOU, Saratoga, CA (US); Cary Michael HAYNER, Half Moon Bay, CA (US); Soo KIM, Fremont, CA (US)

(21) Appl. No.: 18/896,741

(22) Filed: Sep. 25, 2024

Related U.S. Application Data
(60) Provisional application No. 63/590,759, filed on Oct. 16, 2023.

(51) Int. Cl. H01M 10/0569; H01M 4/133; H01M 10/0525; H01M 10/0567

(52) U.S. Cl. CPC H01M 10/0569; H01M 4/133; H01M 10/0525; H01M 10/0567; H01M 2300/0034; H01M 2300/0037

(57) ABSTRACT

Aspects of the disclosure relate to an electrolyte for a battery cell such as a rechargeable battery cell and includes (i) an alkali metal salt, e.g., a lithium salt; (ii) a solvent including an aliphatic sulfone and can further include a fluorinated solvent; and (iii) an additive including an alkene carbonate. The electrolyte can enhance cell power performance, including at lower temperatures (such as −10° C. or lower) without sacrificing cycle life performance at high temperatures. The electrolyte can be included in a battery cell with a hybrid anode and advantageously can be configured with voltage cathode materials.

### CROSS-REFERENCE TO RELATED APPLICATION

This application claims priority to and the benefit of U.S. Provisional Application Ser. No. 63/590,759, entitled “HYBRID ELECTROLYTE,” which was filed on Oct. 16, 2023, the disclosure of which is expressly incorporated by reference herein in its entirety.

### INTRODUCTION

The present disclosure generally relates to an electrolyte for use in battery cells such as high energy lithium battery cells. Battery cells are often used to store and discharge electrical energy.

Aspects of the subject technology can help improve the operation and implementation of battery cells. For example, battery cells having an electrolyte of the present disclosure can improve the stability of high energy battery cells, reduce costs, and increase utilization of such batteries. Batteries with increased energy density and lower costs can help to mitigate climate change by reducing and/or preventing additional greenhouse gas emissions.

### SUMMARY

The present disclosure generally relates to an electrolyte for use in battery cells. The electrolyte includes (i) an alkali metal salt, e.g., a lithium salt; (ii) a solvent including an aliphatic sulfone and can further include a fluorinated solvent; and (iii) an additive including an alkene carbonate, e.g., vinylene carbonate. Advantageously, the electrolyte of the present disclosure can be used in lithium ion battery cells and battery cells that include lithium metal such as in battery cells with intercalate/lithiophilic materials.

In some implementations, the alkali metal salt, e.g., a lithium salt, can be at a concentration of from about 0.5 Molar (M) to about 3 M and can be a mixture of such salts. In other aspects, the solvent includes a fluorinated alkyl carbonate, e.g., fluoroethylene carbonate, as the fluorinated solvent. In some aspects, the solvent includes the aliphatic sulfone in an amount from greater than 0 vol % to about 50 vol % or 60 vol % based on a total volume of the electrolyte. The electrolyte can further include other solvents such as a carbonate solvent, or an ester solvent, or an ether solvent, or a combination thereof.

In accordance with one or more implementations, the alkene carbonate can be vinylene carbonate. The alkene carbonate can be included in the electrolyte in an amount from about 0.1 wt % to about 5 wt %. In further aspects, the additional additives can be included in the electrolyte and in an amount of from about 0.01 wt % up to about 8 wt % based on a total weight of the electrolyte.

In accordance with one or more other implementations, a battery cell includes the electrolyte of the present disclosure. For example, the battery cell can include an electrolyte having (i) a lithium salt; (ii) a solvent including an aliphatic sulfone and a fluorinated solvent; and (iii) an additive including an alkene carbonate. The battery can further include a negative and positive electrode. The negative electrode can include a combination of an intercalation material and a lithiophilic material, and/or lithium metal, and/or can include a current collector and lithium metal formed thereon in-situ. The positive electrode can include a cathode active material including a lithium metal oxide, a lithium metal phosphate, lithium spinel, or a combination thereof. Further, the battery cell can be configured to have a nominal voltage of at least 4 V and/or to have a Negative-to-Positive electrode capacity (N/P) ratio of less than 1.0.

Other implementations of the present disclosure include a method of charging and discharging a battery cell that includes an electrolyte of the present disclosure. Such as battery cell can be configured to have a positive electrode; and a negative electrode, e.g., a negative electrode including an intercalation material and a lithiophilic material. The battery cells of the present disclosure can be configured to have a nominal voltage of at least 4 V and/or to have a Negative-to-Positive electrode capacity (N/P) ratio of less than 1.0.

In one or more implementations, a battery cell having an electrolyte as described herein can be included in a building and/or movable apparatus, e.g., a vehicle. For example, such a battery cell can be configured to power one or more components or systems of a building and/or a vehicle.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having a battery pack in accordance with one or more implementations.

FIG. 1C illustrates a schematic perspective view of a building having a battery pack in accordance with one or more implementations.

FIG. 2A illustrates a schematic perspective view of a battery pack in accordance with one or more implementations.

FIG. 2B illustrates schematic perspective views of various battery modules that may be included in a battery pack in accordance with one or more implementations.

FIG. 2C illustrates a cross-sectional end view of a battery cell in accordance with one or more implementations.

FIG. 2D illustrates a cross-sectional perspective view of a cylindrical battery cell in accordance with one or more implementations.

FIG. 2E illustrates a cross-sectional perspective view of a prismatic battery cell in accordance with one or more implementations.

FIG. 2F illustrates a cross-sectional perspective view of a pouch battery cell in accordance with one or more implementations.

FIGS. 3A, 3B and 3C illustrate a charge curve and formation of solid electrolyte interphase (SEI) on a hybrid anode from components of an electrolyte according to one or more implementations of the present disclosure. In particular, FIG. 3A is a plot of voltage versus normalized capacity illustrating charge curves for charging a battery cell having a hybrid anode and FIGS. 3B and 3C illustrate forming a solid electrolyte interphase on intercalate material or lithium metal, respectively, during a charging operation of the battery cell.

FIGS. 4A and 4B are illustrations of a hybrid anode without and with the benefit of an electrolyte according to one or more implementations of the present disclosure.

FIG. 5 is another illustration of forming solid electrolyte interphases on electrodes from components of an electrolyte according to one or more implementations of the present disclosure.

FIG. 6 illustrates comparative HOMO (Highest Occupied Molecular Orbital) energy levels in eV among sulfolane and various solvents that can be added to an electrolyte of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

As discussed in further detail hereinafter, a battery cell composed of an electrolyte of the present disclosure may be used to store and discharge electrical energy. A battery cell of the present disclosure can be used alone or multiple battery cells can be assembled or packaged together in the same housing, frame, or casing to form a battery subassembly, module and/or battery pack. Further, multiple battery subassemblies or modules can be assembled or packaged together to form a battery pack. The battery cells of a battery subassembly, module and/or pack can be electrically connected to generate a desired voltage output for the battery subassembly, module and/or pack. The battery subassembly, module and/or pack in turn can be electrically connected to a power-consuming component, such as a vehicle and/or an electrical system of a building.

### Vehicles, Battery Packs, Cells

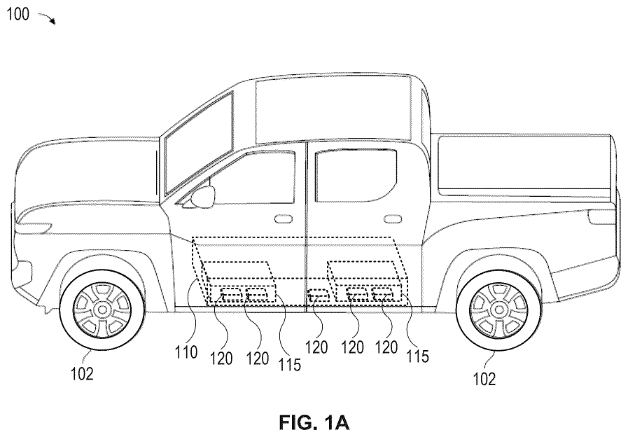

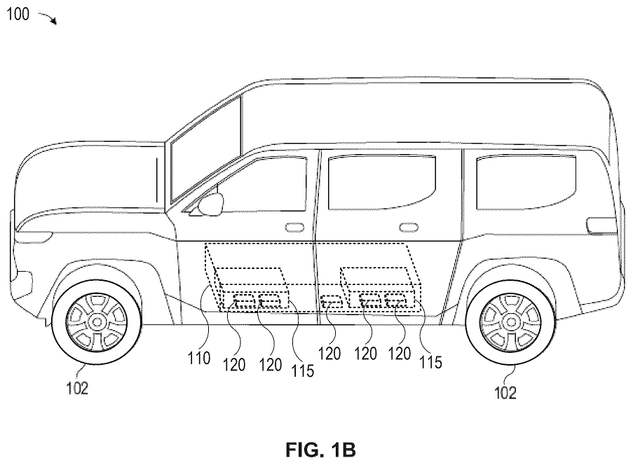

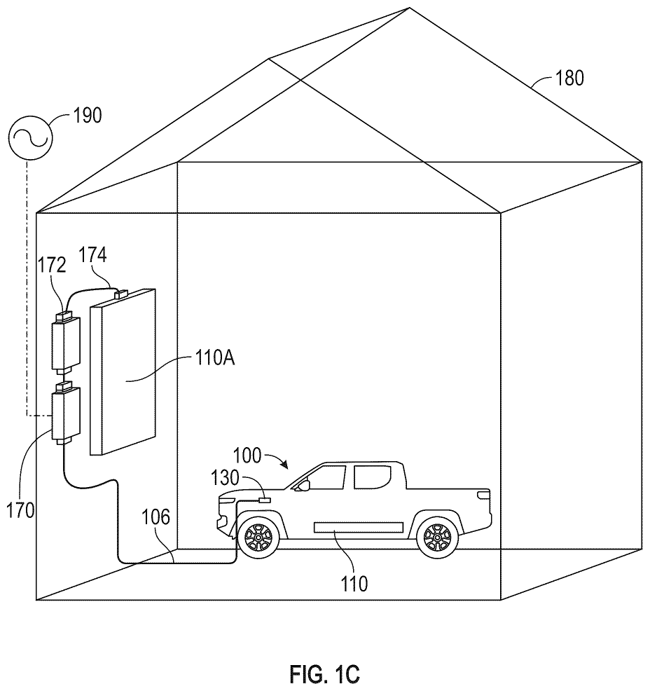

FIG. 1A is a diagram illustrating an example implementation of a movable apparatus as described herein. In the example of FIG. 1A, a movable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically-powered engines, such as a gas-powered engine or a fuel cell powered motor. For example, electric vehicles can be fully electric or partially electric (e.g., hybrid or plug-in hybrid). In various implementations, the vehicle 100 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1A, the vehicle 100 is implemented as a truck (e.g., a pickup truck) having a battery pack 110. As shown, the battery pack 110 may include one or more battery subassemblies (e.g., modules) 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery unit (e.g., a subassembly or module) can include an assembly of cells that can be combined with other elements (e.g., structural frame, thermal management devices) that can protect the assembly of cells from heat, shock and/or vibrations.

For example, the battery cell 120 can be included a battery, a battery unit, a battery subassembly, module and/or a battery pack to power components of the vehicle 100. For example, a battery cell housing of the battery cell 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the movable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110 is implemented in a building 180. For example, the building 180 may be a residential building, a commercial building, or any other building. As shown, in one or more implementations, a battery pack 110 may be mounted to a wall of the building 180.

As shown, the battery 110A that is installed in the building 180 may be couplable to the battery pack 110 in the vehicle 100, such as via: a cable/connector 106 that can be connected to the charging port 130 of the vehicle 100, electric vehicle supply equipment 170 (EVSE), a power stage circuit 172, and/or a cable/connector 174. For example, the cable/connector 106 may be coupled to the EVSE 170, which may be coupled to the battery 110A via the power stage circuit 172, and/or may be coupled to an external power source 190. In this way, either the external power source 190 or the battery 110A that is installed in the building 180 may be used as an external power source to charge the battery pack 110 in the vehicle 100 in some use cases. In some examples, the battery 110A that is installed in the building 180 may also, or alternatively, be coupled (e.g., via a cable/connector 174, the power stage circuit 172, and the EVSE 170) to the external power source 190. For example, the external power source 190 may be a solar power source, a wind power source, and/or an electrical grid of a city, town, or other geographic region (e.g., electrical grid that is powered by a remote power plant). During, for example, times when the battery pack 110 in the vehicle 100 is not coupled to the battery 110A that is installed in the building 180, the battery 110A that is installed in the building 180 can be coupled (e.g., using the power stage circuit 172 for the building 180) to the external power source 190 to charge up and store electrical energy. In some use cases, this stored electrical energy in the battery 110A that is installed in the building 180 can later be used to charge the battery pack 110 in the vehicle 100 (e.g., during times when solar power or wind power is not available, in the case of a regional or local power outage for the building 180, and/or during a period of high rates for access to the electrical grid).

In one or more implementations, the power stage circuit 172 may electrically couple the battery 110A that is installed in the building 180 to an electrical system of the building 180. For example, the power stage circuit 172 may convert DC power from the battery 110A into AC power for one or more loads in the building 180. For example, the battery 110A that is installed in the building 180 may be used to power one or more lights, lamps, appliances, fans, heaters, air conditioners, and/or any other electrical components or electrical loads in the building 180 (e.g., via one or more electrical outlets that are coupled to the battery 110A that is installed in the building 180). For example, the power stage circuit 172 may include control circuitry that is operable to switchably couple the battery 110A between the external power source 190 and one or more electrical outlets and/or other electrical loads in the electrical system of the building 180. In one or more implementations, the vehicle 100 may include a power stage circuit (not shown in FIG. 1C) that can be used to convert power received from the electric vehicle supply equipment 170 to DC power that is used to power/charge the battery pack 110 of the vehicle 100, and/or to convert DC power from the battery pack 110 into AC power for one or more electrical systems, components, and/or loads of the vehicle 100.

In one or more use cases, the battery 110A that is installed in the building 180 may be used as a source of electrical power for the building 180, such as during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery 110A that is installed in the building 180 and/or to power the electrical system of the building 180 (e.g., in a use case in which the battery 110A that is installed in the building 180 is low on or out of stored energy and in which solar power or wind power is not available, a regional or local power outage occurs for the building 180, and/or a period of high rates for access to the electrical grid occurs (as examples)).

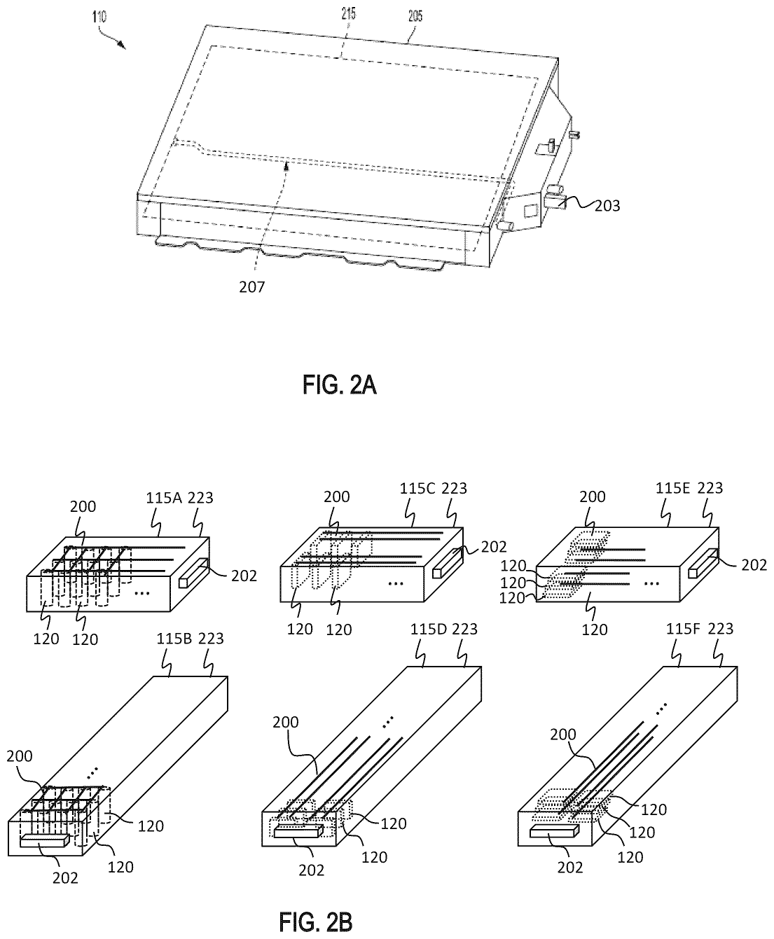

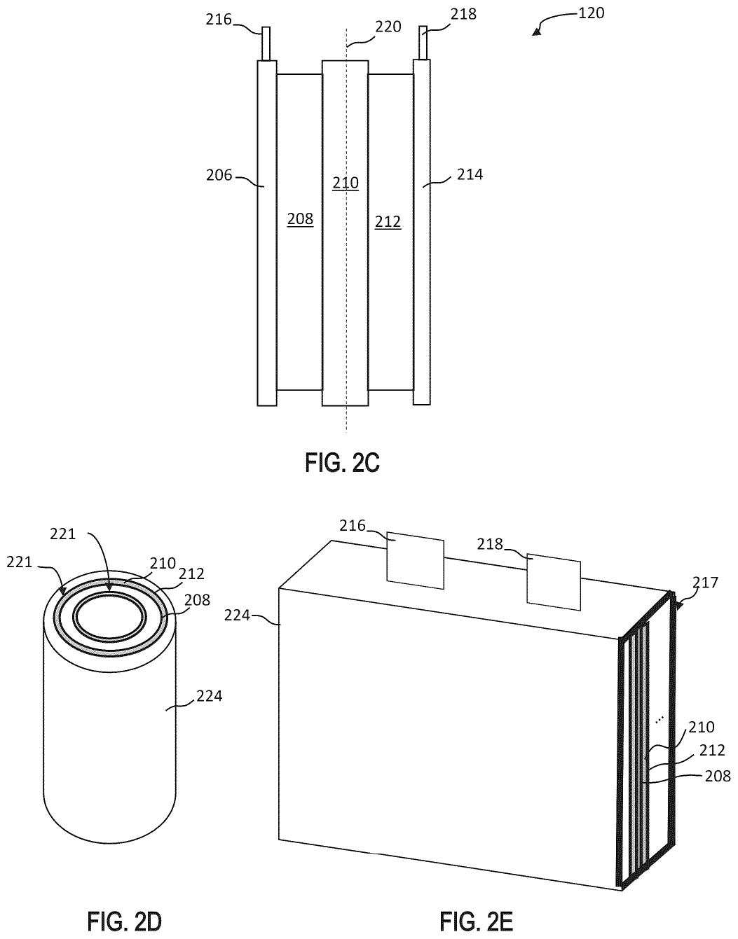

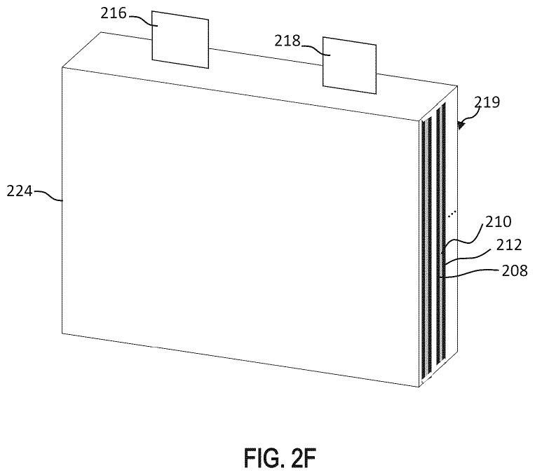

FIG. 2A depicts an example battery pack 110. Battery pack 110 may include multiple battery cells 120 (e.g., directly installed within the battery pack 110, or within batteries, battery units, and/or battery subassemblies) and/or battery modules 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, and/or multiple battery modules 115 within the battery pack frame 205 to generate a desired output voltage for the battery pack 110. The battery pack 110 may also include one or more external connection ports, such as an electrical contact 203 (e.g., a high voltage terminal). For example, an electrical cable (e.g., cable/connector 106) may be connected between the electrical contact 203 and an electrical system of the vehicle 100 or the building 180, to provide electrical power to the vehicle 100 or the building 180.

As shown, the battery pack 110 may include a battery pack frame 205 (e.g., a battery pack housing or pack frame). For example, the battery pack frame 205 may house or enclose one or more battery modules 115 and/or one or more battery cells 120, and/or other battery pack components. In one or more implementations, the battery pack frame 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules 115, battery units, batteries, and/or battery cells 120 within the battery pack frame 205, such as by distributing fluid through the battery pack 110.

For example, the thermal control structures 207 may form a part of a thermal/temperature control or heat exchange system that includes one or more thermal components 215 such as plates or bladders that are disposed in thermal contact with one or more battery modules 115 and/or battery cells 120 disposed within the battery pack frame 205. For example, a thermal component 215 may be positioned in contact with one or more battery modules 115, battery units, batteries, and/or battery cells 120 within the battery pack frame 205. In one or more implementations, the battery pack 110 may include one or multiple thermal control structures 207 and/or other thermal components for each of several top and bottom battery module pairs. As shown, the battery pack 110 may include an electrical contact 203 (e.g., a high voltage connector) by which an external load (e.g., the vehicle 100 or an electrical system of the building 180) may be electrically coupled to the battery modules and/or battery cells in the battery pack 110.

FIG. 2B depicts various examples of battery subassemblies (e.g. modules 115) that may be disposed in the battery pack 110 (e.g., within the battery pack frame 205 of FIG. 2A). In the example of FIG. 2B, a battery module 115A is shown that includes a battery module housing 223 having a rectangular cuboid shape with a length that is substantially similar to its width. In this example, the battery module 115A includes multiple battery cells 120 implemented as cylindrical battery cells. In this example, the battery module 115A includes rows and columns of cylindrical battery cells that are coupled together by an interconnect structure 200 (e.g., a current connector assembly or CCA). For example, the interconnect structure 200 may couple together the positive terminals of the battery cells 120, and/or couple together the negative battery terminals of the battery cells 120. As shown, the battery module 115A may include a charge collector or bus bar 202. For example, the bus bar 202 may be electrically coupled to the interconnect structure 200 to collect the charge generated by the battery cells 120 to provide a high voltage output from the battery module 115A.

FIG. 2B also shows a battery module 115B having an elongate shape, in which the length of the battery module housing 223 (e.g., extending along a direction from a front end of the battery pack 110 to a rear end of the battery pack 110 when the battery module 115B is installed in the battery pack 110) is substantially greater than a width (e.g., in a transverse direction to the direction from the front end of the battery pack 110 to the rear end of the battery pack 110 when the battery module 115B is installed in the battery pack 110) of the battery module housing 223. For example, one or more battery modules 115B may span the entire front-to-back length of a battery pack within the battery pack frame 205. As shown, the battery module 115B may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115B.

In the implementations of battery module 115A and battery module 115B, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115C having a battery module housing 223 having a rectangular cuboid shape with a length that is substantially similar to its width and including multiple battery cells 120 implemented as prismatic battery cells. In this example, the battery module 115C includes rows and columns of prismatic battery cells that are coupled together by an interconnect structure 200 (e.g., a current collector assembly or CCA). For example, the interconnect structure 200 may couple together the positive terminals of the battery cells 120 and/or couple together the negative battery terminals of the battery cells 120. As shown, the battery module 115C may include a charge collector or bus bar 202. For example, the bus bar 202 may be electrically coupled to the interconnect structure 200 to collect the charge generated by the battery cells 120 to provide a high voltage output from the battery module 115C.

FIG. 2B also shows a battery module 115D including prismatic battery cells and having an elongate shape, in which the length of the battery module housing 223 (e.g., extending along a direction from a front end of the battery pack 110 to a rear end of the battery pack 110 when the battery module 115D is installed in the battery pack 110) is substantially greater than a width (e.g., in a transverse direction to the direction from the front end of the battery pack 110 to the rear end of the battery pack 110 when the battery module 115D is installed in the battery pack 110) of the battery module housing 223. For example, one or more battery modules 115D having prismatic battery cells may span the entire front-to-back length of a battery pack within the battery pack frame 205. As shown, the battery module 115D may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115D.

As another example, FIG. 2B also shows a battery module 115E having a battery module housing 223 having a rectangular cuboid shape with a length that is substantially similar to its width and including multiple battery cells 120 implemented as pouch battery cells. In this example, the battery module 115C includes rows and columns of pouch battery cells that are coupled together by an interconnect structure 200 (e.g., a current collector assembly or CCA). For example, the interconnect structure 200 may couple together the positive terminals of the battery cells 120 and couple together the negative battery terminals of the battery cells 120. As shown, the battery module 115E may include a charge collector or bus bar 202. For example, the bus bar 202 may be electrically coupled to the interconnect structure 200 to collect the charge generated by the battery cells 120 to provide a high voltage output from the battery module 115E.

FIG. 2B also shows a battery module 115F including pouch battery cells and having an elongate shape in which the length of the battery module housing 223 (e.g., extending along a direction from a front end of the battery pack 110 to a rear end of the battery pack 110 when the battery module 115E is installed in the battery pack 110) is substantially greater than a width (e.g., in a transverse direction to the direction from the front end of the battery pack 110 to the rear end of the battery pack 110 when the battery module 115E is installed in the battery pack 110) of the battery module housing 223. For example, one or more battery modules 115E having pouch battery cells may span the entire front-to-back length of a battery pack within the battery pack frame 205. As shown, the battery module 115E may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115E.

In various implementations, a battery pack 110 may be provided with one or more of any of the battery modules 115A, 115B, 115C, 115D, 115E, and 115F. In one or more other implementations, a battery pack 110 may be provided without battery modules 115 (e.g., in a cell-to-pack implementation).

In one or more implementations, multiple battery modules 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery modules 115. For example, the battery pack 110 may have a cell-to-pack configuration in which battery cells 120 are arranged directly into the battery pack 110 without assembly into a battery module 115 (e.g., without including a separate battery module housing 223). For example, the battery pack 110 (e.g., the battery pack frame 205) may include or define a plurality of structures for positioning of the battery cells 120 directly within the battery pack frame 205.

FIG. 2C illustrates a cross-sectional end view of a portion of a battery cell 120. As shown in FIG. 2C, a battery cell 120 may include an anode 208, a cathode 212, a separator 220 therebetween to separate the anode 208 from the cathode 212, and an electrolyte 210 according to the present disclosure. As shown, the anode 208 may include or be electrically coupled to a first current collector 206 (e.g., a metal layer such as a layer of copper foil or other metal foil). As shown, the cathode 212 may include or be electrically coupled to a second current collector 214 (e.g., a metal layer such as a layer of aluminum foil or other metal foil). As shown, the battery cell 120 may include a first terminal 216 (e.g., a negative terminal) coupled to the anode 208 (e.g., via the first current collector 206) and a second terminal 218 (e.g., a positive terminal) coupled to the cathode (e.g., via the second current collector 214).

In one or more implementations, the battery cell 120 may be implemented as a lithium ion battery cell in which the anode 208 is formed from an intercalate material (e.g., graphite or silicon-carbon), or the battery cell 120 may be implemented as a lithium metal battery cell in which the anode 208 includes metallic lithium, or the battery cell 120 may be implemented as a hybrid battery cell in which the anode 208 includes a combination of intercalation material and a material that can promote lithium metal deposition. For example, anode 208 can be composed of lithiophilic material in combination with intercalation materials (e.g., graphite or silicon-carbon). In such an aspect, the lithiophilic materials induce metallic lithium deposition thereon during normal charging operation of the battery cell. In these implementations, lithium ions can shuttle between the anode 208 and cathode 212 through electrolyte 210 during discharge and charge of the battery cell 120.

In other implementations, anode 208 can be formed on the first current collector 206 in situ during charging of the battery cell, e.g., an anode-free cell. In such an aspect, a negative electrode can include the current collector 206 (e.g., a metal foil such as a copper foil or carbon foil, or combinations thereof) with the in situ-formed anode, e.g., metallic lithium, on a surface of the current collector facing polymer electrolyte 220. In such examples, a battery cell may be configured to lack an anode active material in an uncharged state.

In various implementations, the anode 208, the separator 220, the cathode 212, and electrolyte 210 of FIG. 2C can be packaged into a battery cell housing having any of various shapes, and/or sizes, and/or formed from any of various suitable materials. For example, battery cells 120 can have a cylindrical, rectangular, square, cubic, flat, pouch, elongated, or prismatic outer shape. As depicted in FIG. 2D, for example, a battery cell such as the battery cell 120 may be implemented as a cylindrical cell. In the example of FIG. 2D, the battery cell 120 includes a cell housing 224 having a cylindrical outer shape. For example, the anode 208, the separator 220, and the cathode 212 may be rolled into one or more substantially cylindrical windings 221. As shown, one or more windings 221 of the anode 208, the separator 220, and the cathode 212 may be disposed within the cell housing 224. In addition, separator layers may be disposed between adjacent windings 221. However, the cylindrical cell implementation of FIG. 2D is merely illustrative, and other implementations of the battery cells 120 are contemplated.

For example, FIG. 2E illustrates an example in which the battery cell 120 is implemented as a prismatic cell. As shown in FIG. 2E, the battery cell 120 may have a cell housing 224 having a right prismatic outer shape. As shown, one or more layers of the anode 208, the cathode 212, and the separator 220 disposed therebetween may be disposed within the cell housing 224 having the right prismatic shape. As examples, multiple layer of the anode 208, separator 220, and cathode 212 can be stacked (with an additional separator layer between adjacent stacks), or a single layer of the anode 208, separator 220, and cathode 212 can be formed into a flattened spiral shape and provided in the cell housing 224 having the right prismatic shape. In the implementation of FIG. 2E, the cell housing 224 has a relatively thick cross-sectional width 217 and is formed from a rigid material. For example, the cell housing 224 in the implementation of FIG. 2E may be formed from a welded, stamped, deep drawn, and/or impact extruded metal sheet, such as a welded, stamped, deep drawn, and/or impact extruded aluminum sheet. For example, the cross-sectional width 217 of the cell housing 224 of FIG. 2E may be as much as, or more than 1 millimeter (mm) to provide a rigid housing for the prismatic battery cell. In one or more implementations, the first terminal 216 and the second terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the first terminal 216 and the second terminal 218 outside the cell housing 224 (e.g., for contact with an interconnect structure 200 of FIG. 2B). However, this implementation of FIG. 2E is also illustrative and yet other implementations of the battery cell 120 are contemplated.

For example, FIG. 2F illustrates an example in which the battery cell 120 is implemented as a pouch cell. As shown in FIG. 2F, one or more layers of the anode 208, the cathode 212, and the separator 220 disposed therebetween may be disposed (e.g., with an additional separator layers between the anode/separator/cathode layers) within the cell housing 224 that forms a flexible or malleable pouch housing. In the implementation of FIG. 2F, the cell housing 224 has a relatively thin cross-sectional width 219. For example, the cell housing 224 in the implementation of FIG. 2F may be formed from a flexible or malleable material (e.g., a foil, such as a metal foil, or film, such as an aluminum-coated plastic film). For example, the cross-sectional width 219 of the cell housing 224 of FIG. 2F may be as low as, or less than 0.1 mm, 0.05 mm, 0.02 mm, or 0.01 mm to provide flexible or malleable housing for the pouch battery cell. In one or more implementations, the first terminal 216 and the second terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the first terminal 216 and the second terminal 218 are formed on the same side (e.g., a top side) of the battery cell 120. However, this is merely illustrative and, in other implementations, the first terminal 216 and the second terminal 218 may formed on two different sides (e.g., opposing sides, such as a top side and a bottom side) of the battery cell 120. The first terminal 216 and the second terminal 218 may be formed on a same side or difference sides of the cylindrical cell of FIG. 2D in various implementations.

In one or more implementations, a battery module 115, a battery pack 110, a battery unit, or any other battery may include some battery cells 120 that are implemented with a polymer electrolyte of the present disclosure. One or more of the battery cells 120 may be included in a battery module 115 or a battery pack 110, such as to provide an electrical power supply for components of the vehicle 100, the building 180, or any other electrically powered component or device. The cell housing 224 of the battery cell 120 can be disposed in the battery module 115, the battery pack 110, or installed in any of the vehicle 100, the building 180, or any other electrically powered component or device.

### Electrolyte

As discussed above, a battery cell (e.g., battery cell 120) including an electrolyte of the present disclosure can be used to store and discharge electrical energy and implemented in a building and/or movable apparatus. The electrolyte of the present disclosure can be used in lithium ion battery cells and battery cells that include lithium metal or a hybrid electrode.

Conventional electrolytes typically are designed to enhance the cell performance for a particular active material within the battery electrode. For example, the electrolytes for graphite are designed, in part, to form stable solid electrolyte interphase (SEI) structures on graphite and solvated lithium ion structures and electrolytes for a lithium metal anode are designed, in part, for stable SEI films on the surface of the lithium metal anode with good cyclability.

Aspects of the subject technology described herein relate to an electrolyte that includes: (i) an alkali metal salt, e.g., a lithium salt; (ii) a solvent including an aliphatic sulfone and can further include a fluorinated solvent; and (iii) an additive including an alkene carbonate. According to implementations of the present disclosure, an electrolyte combining alkali metal salt(s), an aliphatic sulfone, e.g., sulfolane, a fluorinated solvent, e.g., fluoroethylene carbonate, and (iii) an additive including an alkene carbonate, e.g., vinylene carbonate, can form a stable SEI on various anodes including graphite anodes, alkali metal anodes, e.g., lithium and/or sodium metal, and hybrid anodes. Further, the electrolyte of the present disclosure can enhance performance of a hybrid anode and has an advantage that including the aliphatic sulfone can increase the nominal voltage of the battery cell with the electrolyte to a nominal voltage of at least 4 V, e.g., at least 4.2V. Further, the combination of components of the electrolyte of the present disclosure, can enhance cell power performance, including at lower temperatures (such as −10° C. or lower) without sacrificing cycle life performance at high temperatures.

In certain aspects, the alkali metal salt of the electrolyte of the present disclosure can include one or more alkali metal salts and in an amount of from about 0.5 Molar (M) to about 3 M, e.g., from about 1 M to about 3 M or any range therebetween. Such salts can include, without limitation, LiPF₆, LiBF₄, lithium difluoro (oxalato) borate (LiDFOB), lithium bis(fluorosulfonyl) imide (LiFSI), lithium bis(trifluoromethanesulfonyl)imide (LiTFSI), lithium nitrate (LiNO₃), or mixtures thereof and sodium (Na) or potassium (K) analogs thereof as well as mixtures of the respective Na or K analogs.

The electrolyte of the present disclosure includes an aliphatic sulfone. The aliphatic sulfone can be acyclic or cyclic. Such aliphatic solfones can include, without limitation, tetramethylene sulfone (sulfolane), 1-methyltrimethylene sulfone (MTS), ethylmethyl sulfone (EMS), ethyl-sec-butyl sulfone (EsBS), ethyl-iso-butyl sulfone (EiBS), ethyl-iso-propyl sulfone (EiPS), trifluoropropylmethyl sulfone (FPMS), dimethylsulfone, methanesulfonyl fluoride, etc. or a combination thereof. In some implementations, the aliphatic sulfone can be in an amount from greater than 0 vol % to about 60 vol % based on a total volume of the electrolyte, such as from about 0.5 vol % to about 45 vol %. of the total volume of the electrolyte.

The electrolyte of the present disclosure can include a fluorinated solvent The fluorinated solvent of the electrolyte can be selected among fluorinated alkyl ether or a fluorinated alkyl carbonate such as tetrafluoropropyl ether, fluoroethylene carbonate (FEC), a fluorinated ethyl methyl carbonate (EMC), a fluorinated dimethyl carbonate (DMC), a fluorinated diethyl carbonate (DEC), a fluorinated ethyl methyl carbonate (EMC), a fluorinated ethylene carbonate (EC), a fluorinated propylene carbonate (PC), fluorobenzene, etc., or a combination thereof. In some implementations, the fluorinated solvent of the electrolyte can be in an amount of up to about 10 wt % based on a total weight of the electrolyte, including greater than about 0.1 wt % of a total weight of the electrolyte, such as greater than about 0.5 wt %, 1 wt %, or from about 0.1 wt % to about 10 wt % of the total weight of the electrolyte.

The electrolyte of the present disclosure can include additional solvents such as ether solvents, ester solvents, carbonate solvents, or combinations thereof. Such ether solvents can be selected among dimethyl ether (DME), diethyl ether, 1,2 dimethoxy ethane, etc., or combinations thereof, and such carbonate solvents can be selected among dimethyl carbonate (DMC), diethyl carbonate (DEC), and ethyl methyl carbonate (EMC), ethylene carbonate (EC), propylene carbonate (PC), fluoroethylene carbonate (FEC), etc., or a combination thereof.

In further aspects, the electrolyte of the present disclosure includes an additive of at least one or more alkene carbonates such as vinylene carbonate (VC), vinylethylene carbonate (VEC), not limited to cyclic and extended to linear alkene carbonates. Such one or more alkene carbonates can be in an amount of up to about 8 wt % such as up to about 5 wt % including from about 0.1 wt % to about 8 wt % based on a total weight of the electrolyte, e.g., from about 0.5 wt % to about 5 wt % of the total weight of the electrolyte.

In one or more implementations, the electrolyte of the present application can include one or more additional additives. Such additional additives can be selected from adiponitrile, 1,3,6-hexanetricarbonitrile (HTCN), tris(trimethylsilyl)phosphite (TMPSi), tris(trimethylsilyl)phosphate (TMSPa), ethylene sulfite (ES), butadiene sulfone (BS), prop-1-ene-1,3-sultone (PES), LiPF₂O₂, tris(trimethylsilyl) borate, triallyl phosphate (TAP), tetrafluoropropyl ether, fluorbenzene, etc., or a combination thereof. Such additional additives can be in an amount of from about 0.01 wt % and up to a total weight of all additives of about 8 wt % of a total weight of the electrolyte.

Table 1 below provides example electrolyte formulations of the present disclosure. For example, formulations from Table 1 can combine Salt(s) (A), Solvent(s) (B) and Additive(s) (C) according to the following equations:

$$A 1 ( 0.2 M - 3 M ) + A 2 ( 0.05 M - 3 M ) + Ax + 1 ( 0.05 M - 1 M ) \qquad Eq . 1$$

$$Eq . 2$$

$$B 1 ( 0.5 - 60 vol \% ) + B 2 ( 0.5 - 60 vol \% ) … Bx + 1 ( 0.01 - 20 vol \% )$$

$$C 1 ( 0.1 - 5 wt \% ) + C 2 ( 0.01 - 5 wt \% ) … Cx + 1 ( 0.01 - 5 wt \% ) \qquad Eq . 3$$

| Salt (A) | Solvent (B) | Additive (C) |
|---|---|---|
| LiPF₆ | Sulfolane | Vinylene carbonate VC |
| LiBF₄ | Linear aliphatic sulfones | Adiponitrile |
| LiDFOB | ethylene carbonate (EC) | HTCN |
| Lithium bis (fluorosulfonyl) | DEC | TMSPa |
| imide (LiFSI) | DMC | TMSPi |
| LiTFSI | FEC | ES |
| LiNO₃ | PC | BS |
| Na & K analogs | EMC | PES |
| | Fluorinated EMC | LiPF2O2 |
| | Ethyl propionate, methyl | Tris(trimethylsilyl) borate |
| | butyrate | Triallyl phosphate |
| | 1,2 dimethoxyethane | Fluorobenzene |
| | Linear sulfones | Tetrafluoropropyl ether |
| | | Fluorinated ethers |

The electrolyte of the present disclosure can be used in lithium or sodium ion battery cells and battery cells that include an alkali metal, e.g., lithium or sodium metal.

Alternatively, the electrolyte of the present disclosure can be included in battery cells configured with an anode less or anode free negative electrode in which lithium and/or sodium metal is deposited during charging of the cell. For example, anodes that may be included in a battery cell in accordance with the present disclosure include an anode that may be formed in situ on a current collector, e.g., an anode-free cell. In such an aspect, a negative electrode can include a current collector (e.g., a metal foil such as a copper foil or carbon-coated foil) with the in situ-formed lithium metal anode on a surface of the current collector facing the polymer electrolyte. In such examples, a battery cell may be configured to lack an anode active material in an uncharged state.

As another alternative, the electrolyte of the present disclosure can be included in a battery cell that has an anode including one or more lithiophilic materials. lithiophilic materials of the present disclosure induce reversible lithium metal deposition on the material during a normal operating charge cycle of the cell. Such lithiophilic materials are not the same as intercalation materials, which do not induce reversible lithium metal deposition on the material during a normal operating charge cycle of the cell. The lithiophilic materials of the present disclosure can be used alone or in combination with one or more intercalation materials. For example, a battery cell of the present disclosure can include an anode composed of one or more lithiophilic materials in combination with one or more intercalation materials, i.e., a hybrid electrode. In some aspects, such a hybrid electrode can be arranged to have a layer of the lithiophilic material on a layer of the intercalation material. In other aspects, such a hybrid electrode can have less than 50 wt % of the intercalation materials, e.g., less than 50 wt % graphite, relative to the total weight of the lithiophilic material and intercalation material. A hybrid electrode including one or more lithiophilic materials in combination with one or more intercalation materials can have an Negative-to-Positive electrode capacity (N/P) ratio of less than 1.0.

A wide variety of lithiophilic materials can be used, including, without limitation: carbon-type materials that induce reversible lithium metal deposition thereon during a normal operating charge cycle of the cell, metal or metal alloy materials, or polymeric materials. Examples of carbon-type materials include, but are not limited to, multi-walled carbon nanotubes (MWCNT) having defects, such as metal doped MWCNT, e.g., Co/MWCNT, Fe/MWCNT, ZnO-coated carbon nanotubes, boron-doped graphene, nitrogen-doped graphene, a metal nanoparticle graphene cage (e.g., a gold-graphene cage), zinc oxide-coated carbon nanotubes, FeN/N-doped graphene, Ag/N-doped carbon macroporous fiber, Co/CoxN/N-doped carbon, MOF-derived ZnO/N-doped carbon sheet, PVDF coated hollow carbon, SnS2/carbon fiber, Mo2N/Carbon nanofiber, TiC/C core-shell, and MXene (few-atoms-thick layers of transition metal carbides, nitrides, or carbonitrides). A graphene cage can comprise metallic nanoparticles, for example, gold nanoparticles. Lithium can be preferentially deposited inside the graphene cage at gold nanoparticles. Examples of metal or metal alloy materials include, but are not limited to, silver, gold, copper oxide, bismuth-nanosheet, copper-copper oxide-nickel alloy, copper-lithium oxide alloy, antimony-lithium alloy, aluminum-lithium alloy, zinc-lithium alloy, Li15Au4, LiZn, manganese-doped Li—LiB, and silver-incorporated metal-organic framework. Examples of polymeric materials include, but are not limited to, framework porphyrin, LiPON, PVDF-PAN, and polydopamine (PDA).

A wide variety of intercalation materials can be used with the lithiophilic materials, including, without limitation: graphitic carbon (e.g., ordered or disordered carbon with sp2 hybridization, artificial or natural graphite, or blends thereof) such as in an amount of less than 50 weight percent, a metal oxide, e.g., lithium titanate, silicon, a silicon-based material (e.g., silicon-based carbon composite, oxide, carbide, a pre-lithiated silicon material), alloy material types, etc. or a combination of any two or more thereof.

The battery cell of the present disclosure further can include a positive electrode that comprises a cathode active material. A wide variety of cathode materials can be used in a battery cell including an electrolyte of the present disclosure. Such cathode active materials can be composed of, without limitation: one or more lithium metal oxides, e.g., a lithium cobalt oxide, a lithium manganese oxide, a lithium nickel manganese cobalt oxide (NMC), lithium nickel cobalt aluminum oxide (NCA), over-lithiated oxides (OLO), which includes an excess stoichiometric mole amount of lithium in a lithium metal oxide, etc., and/or a high-entropy lithium oxide cathode, and/or a lithium metal phosphate, such as a lithium iron phosphate, lithium manganese phosphate, lithium manganese iron phosphate, etc., lithium spinel, or any combinations thereof. In some aspects, the OLO active material has a formula of: Li_{1+y}M_{1-y}O₂, where 0<y≤0.4 and M is a transition metal such as Ni and/or Mn, which may be doped with Al. In other aspects, the OLO active material has less than about 7 wt % cobalt, such as less than 2 wt % cobalt.

In accordance with aspects of the subject technology, a method is provided that includes: obtaining a battery having a cell (e.g., a battery cell 120), the cell including a cathode (e.g., cathode 212), an anode (e.g., anode 208), a separator (e.g., separator 220) and an electrolyte of the present disclosure (e.g., electrolyte 210), and operating the cell by charging the cell of the battery, and/or discharging the cell of the battery. Discharging the battery cell can provide electrical power to a power-consuming component (e.g., a vehicle and/or an electrical system of a building).

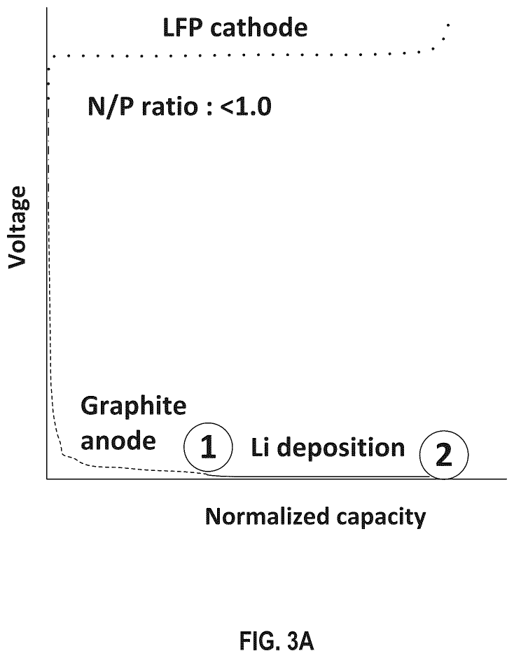

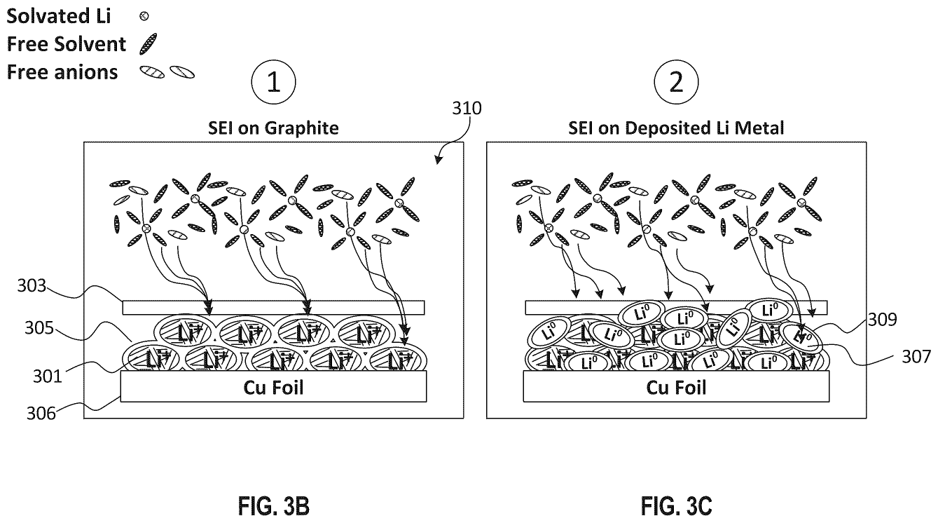

As explained above, the electrolyte of the present disclosure can be included in a battery cell that has a hybrid electrode. For example a battery cell of the present disclosure can include an anode composed of one or more lithiophilic materials in combination with one or more intercalation materials, i.e., a hybrid electrode. FIGS. 3A-3C illustrate a charge curve and formation of solid electrolyte interphase (SEI) on a hybrid anode from components of the electrolyte according to one or more implementations of the present disclosure. As illustrated in FIGS. 3A and 3B, when such a battery cell undergoes a charge operation, an SEI (305) can form initially on the intercalate material (shown with lithium ions therein, 301) from components of the electrolyte (310). As further illustrated in this example, the hybrid anode includes a layer of lithographic material (303) and intercalate material (301) on a copper current collector (306).

As charging continues, the intercalate material tends to be saturated with lithium ions and lithium metal (307) can deposit on the anode as illustrated in FIGS. 3A and 3C. The lithographic material (303) can facilitate nucleation and lithium metal deposition. As further illustrated in FIG. 3C, an SEI (309) can form on deposited lithium metal from components of the electrolyte (310). As such, an electrolyte according to the present disclosure can advantageously form a stable SEI on intercalate material and also stabilize lithium metal plating. Further, implementation of an electrolyte with a mixture of lithium salts can facilitate an inorganic SEI due to the solvation structure formed when VC, FEC, and sulfolane are present, for example, which leads to an enhanced performance of the hybrid anode.

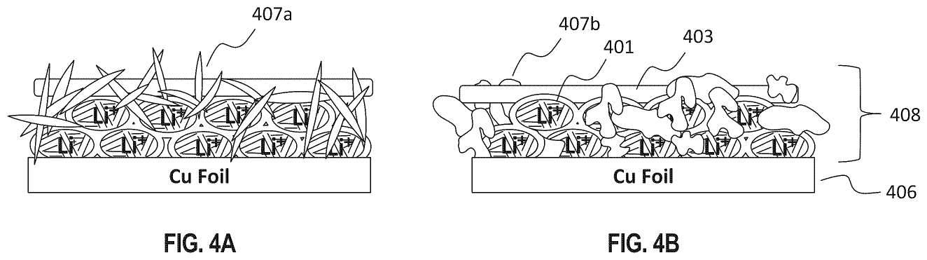

FIGS. 4A and 4B are illustrations of a hybrid anode without and with the benefit of an electrolyte according to one or more implementations of the present disclosure. As illustrated, hybrid anode (408) includes intercalate material (401) and lithiophilic material (403) on a copper current collector (406). During a normal charging operation, a battery cell with the hybrid anode that does not include and electrolyte according to the present disclosure (FIG. 4A) has a higher propensity to deposit lithium metal in the form of dendrites (407a) as compared to the deposition of lithium metal in less defined structures (FIG. 4B, 407b). The electrolytes of the present disclosure advantageously can allow formation of a hybrid SEI which allows for the plating and stripping of lithium metal into large nucleated particles and thus lowers the propensity of dendrite formation. Further nucleation and a more dense lithium metal deposition can advantageously improve long term cycling, reduce “dead” lithium, improve coulombic efficiency, and/or reduce the propensity of a short circuit.

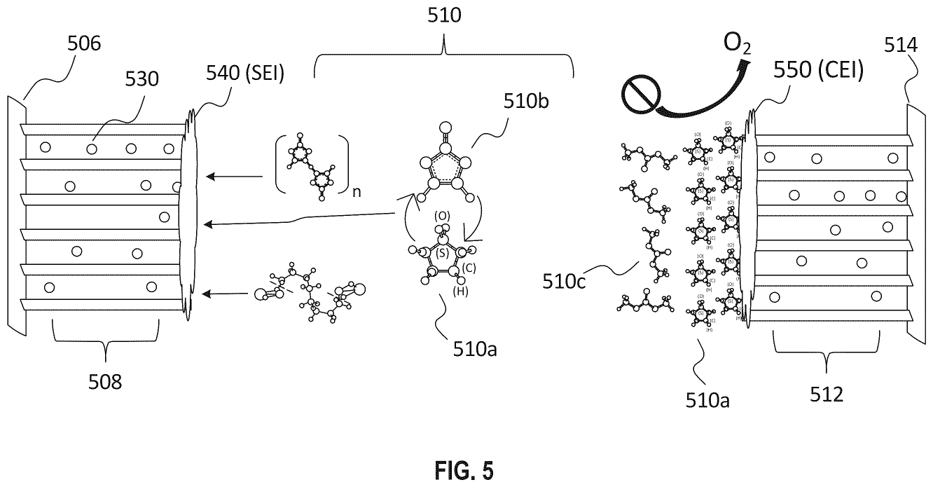

FIG. 5 is another illustration of forming solid electrolyte interphases on electrodes from components of the electrolyte according to one or more implementations of the present disclosure. As shown in the figure, a battery cell having anode 508 (graphite) on a copper current collector 506, a cathode 512 on an aluminum current collector 514 and an electrolyte (510) according to one or more implementations of the present disclosure. During operation of the battery cell, lithium ions (530) can shuttle between the anode (508) and cathode (512) through the electrolyte (510). Further components of the electrolyte can form an SEI on the anode (540) and a cathode-electrolyte interphase (CEI) layer (550). For this example, the electrolyte components include an aliphatic sulfone, e.g., sulfolane (510a), vinylene carbonate (510b) and a carbonate solvent (510c).

The interaction between sulfolane (510a), vinylene carbonate (510b) can synergistically facilitates ring opening of sulfolane (510a) to form the SEI (540) which include lithium conducting moieties. This interaction is also facilitated by salts that can form LiF rich SEIs. The combinatorial effect of the sulfolane (510a), vinylene carbonate (510b) and a lithium salt or mixture thereof advantageously forms an SEI that promotes Li intercalation with the anode (e.g., graphite) and can also facilitate Li metal deposition with lithiophilic materials in hybrid anodes.

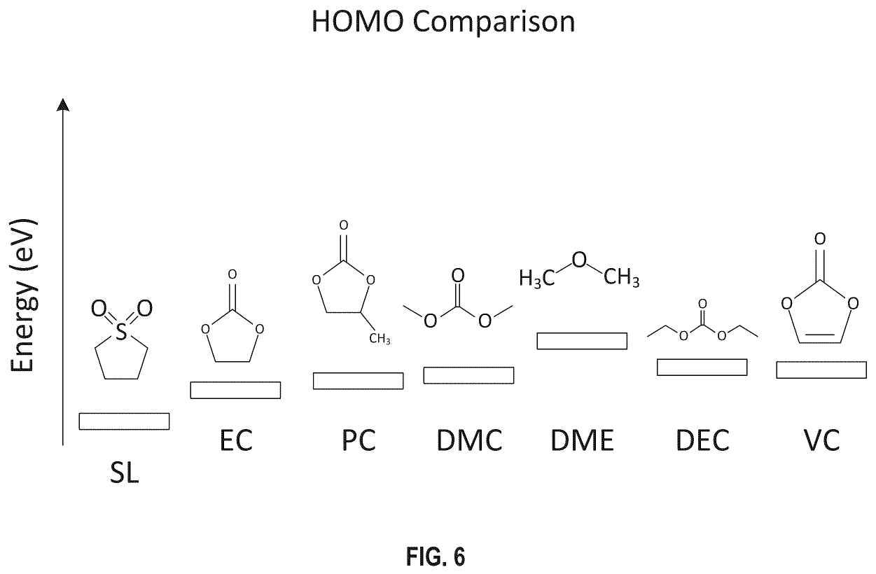

As further illustrated in FIGS. 5 and 6, when the electrolyte combines sulfolane (510a), with additional solvents having a lower HOMO (Highest Occupied Molecular Orbital) levels than sulfolane, sulfolane (510a) preferentially concentrates at the cathode (512) displacing other solvents (510c) from the cathode. Such a concentration of the sulfolane protects the cathode and reduces carbon dioxide and other undesirable gas generation. The high oxidation potential and affinity to participate in forming an CEI reduces the oxygen generation and can help against transition metal dissolution in high voltage cathodes (>4.0V).

FIG. 6 illustrates comparative HOMO energy levels in eV among sulfolane and various solvents that can be added to the electrolyte of the present disclosure. Hence, in some implementations, a battery cell having an electrolyte of the present disclosure can be configured to have a high nominal voltage, e.g., at least 4 V to 4.3V, by including high voltage cathode materials. As used herein, nominal voltage refers to the average terminal voltage of a cell or battery during its discharge.

Aspects of the subject technology can help improve the operation and implementation of battery cells. For example, battery cells having an electrolyte of the present disclosure can improve the stability of high energy battery cells such as lithium metal batteries and increase utilization of such batteries. Batteries with increased energy density can help to mitigate climate change by reducing and/or preventing additional greenhouse gas emissions.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, the term “coupled” or the like may refer to being directly coupled. In another aspect, the term “coupled” or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it may be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An electrolyte, comprising:
(i) an alkali metal salt in an amount of from about 0.5 Molar (M) to about 3 M;
(ii) a solvent; and
(iii) an additive in an amount of from 0.1 wt % to 8 wt % based on a total weight of the electrolyte;
wherein the solvent includes an aliphatic sulfone in an amount from greater than 0 vol % to 60 vol % based on a total volume of the electrolyte, and a fluorinated alkyl carbonate;
wherein the additive includes vinylene carbonate (VC) in an amount from 0.1 wt % to 5 wt % based on the total weight of the electrolyte.

2. The electrolyte of claim 1, wherein the alkali metal salt comprises a mixture of lithium salts.

3. The electrolyte of claim 1, wherein the aliphatic sulfone comprises sulfolane.

4. The electrolyte of claim 1, wherein the fluorinated alkyl carbonate comprises fluoroethylene carbonate (FEC).

5. The electrolyte of claim 1, wherein the fluorinated alkyl carbonate comprises fluoroethylene carbonate (FEC) in an amount of greater than 0.1 wt % of the total weight of the electrolyte.

6. The electrolyte of claim 1, wherein the electrolyte further comprises a carbonate solvent, an ester solvent, an ether solvent, or a combination thereof.

7. The electrolyte of claim 1, wherein the additive includes: adiponitrile, 1,3,6-hexanetricarbonitrile (HTCN), tris(trimethylsilyl)phosphite (TMPSi), tris(trimethylsilyl)phosphate (TMSPa), ethylene sulfite (ES), butadiene sulfone (BS), prop-1-ene-1,3-sultone (PES), LiPF₂O₂, tris(trimethylsilyl) borate, triallyl phosphate (TAP), tetrafluoropropyl ether, fluorobenzene, or a combination thereof.

8. A battery cell, comprising:
a negative electrode including an intercalation material and a lithiophilic material; and
an electrolyte that comprises: (i) a lithium salt; (ii) a solvent including an aliphatic sulfone and a fluorinated solvent; and (iii) an additive including an alkene carbonate.

9. The battery cell of claim 8, further comprising a positive electrode that comprises a cathode active material including a lithium metal oxide, a lithium metal phosphate, lithium spinel, or a combination thereof.

10. The battery cell of claim 8, wherein the battery cell is configured to have a nominal voltage of at least 4 V.

11. The battery cell of claim 8, wherein the intercalation material is a carbonaceous material.

12. The battery cell of claim 8, wherein the negative electrode includes lithium metal when the battery cell is in a charged state.

13. The battery cell of claim 8, wherein the alkene carbonate comprises vinylene carbonate (VC).

14. The battery cell of claim 8, wherein the aliphatic sulfone comprises sulfolane.

15. The battery cell of claim 8, wherein the fluorinated solvent comprises fluoroethylene carbonate (FEC).

16. The battery cell of claim 8, wherein the lithium salt is in an amount of from about 0.5 Molar (M) to about 3 M; wherein the aliphatic sulfone comprises sulfolane in an amount of greater than 0 vol % to about 60 vol % and the fluorinated solvent comprises fluoroethylene carbonate (FEC) in an amount of up to 5 wt %; and wherein the alkene carbonate comprises vinylene carbonate (VC) up to about 5 wt %.

17. A vehicle comprising the battery cell of claim 8.

18. A method, comprising:
charging and discharging a battery cell;
wherein the battery cell comprises:
a positive electrode;
a negative electrode including an intercalation material and a lithiophilic material; and
an electrolyte that comprises: (i) a lithium salt; (ii) a solvent including an aliphatic sulfone and a fluorinated solvent; and (iii) an additive including an alkene carbonate.

19. The method of claim 18, wherein the Negative-to-Positive electrode capacity (N/P) ratio of the battery cell is less than 1.0.

20. The method of claim 18, wherein the intercalation material is a carbonaceous material.
